(19) United States
(12) Patent Application Publication
(10) Pub. No.: US 2023/0269732 A1
(43) Pub. Date: Aug. 24, 2023

(54) WIRELESS COMMUNICATION METHOD AND TERMINAL DEVICE

(71) Applicant: GUANGDONG OPPO MOBILE TELECOMMUNICATIONS CORP., LTD., Dongguan (CN)

(72) Inventors: Yi Hu, Dongguan (CN); Haitao Li, Dongguan (CN)

(21) Appl. No.: 18/137,868

(22) Filed: Apr. 21, 2023

Related U.S. Application Data
(63) Continuation of application No. PCT/CN2020/138085, filed on Dec. 21, 2020.

(51) Int. Cl. H04W 72/1263; H04W 76/28

(52) U.S. Cl. CPC H04W 72/1263; H04W 76/28; H04W 84/06

(57) ABSTRACT

Embodiments of the present disclosure provide a wireless communication method and a terminal device. The method includes: transmitting a Scheduling Request, SR, on an uplink carrier; and entering, when the SR is in a pending state after a target time offset following transmission of the SR, a Discontinuous Reception, DRX, active time, wherein the target time offset is determined based on a transmission delay of the SR on the uplink carrier and a signal transmission delay on at least one downlink carrier, the at least one downlink carrier being a downlink carrier activated between a terminal device and a base station.

### CROSS-REFERENCE TO RELATED APPLICATIONS

This application is a continuation of International Application No. PCT/CN2020/138085 filed on Dec. 21, 2020, the entire contents of which are incorporated herein by reference.

### FIELD

Embodiments of the present disclosure relate to the field of communication, and more particularly, to a wireless communication method and terminal device.

### BACKGROUND

In New Radio (NR), a network device may configure a Discontinuous Reception (DRX) for a terminal device, so that the terminal device may monitor the Physical Downlink Control Channel (PDCCH) during a DRX active time. In a Terrestrial Network (TN), a terminal device may enter a DRX active time when a Scheduling Request (SR) is transmitted on a Physical Uplink Control Channel (PUCCH) and the SR is in a pending state.

Compared with a TN, in a Non-Terrestrial Network (NTN), the signal transmission delay between a terminal device and a network device is greatly increased. From a point of view of terminal energy saving, it is necessary to introduce, for a case when the terminal device is triggered by the SR to enter the DRX active time, an offset determined based on Round-Trip Time (RTT). As for a scenario of Carrier Aggregation (CA) between a TN and an NTN, or a scenario of NTN CA with transparent forwarding by different satellites, there are great differences in signal transmission paths and time delays on different carriers between the terminal device and the terrestrial network, so how to determine the time offset is an urgent technical problem to be solved by the present disclosure.

### SUMMARY

Embodiments of the present disclosure provide a wireless communication method and a terminal device.

In a first aspect, a wireless communication method is provided. The method includes: transmitting a Scheduling Request, SR, on an uplink carrier; and entering, when the SR is in a pending state after a target time offset following transmission of the SR, a Discontinuous Reception, DRX, active time. The target time offset is determined based on a transmission delay of the SR on the uplink carrier and a signal transmission delay on at least one downlink carrier, the at least one downlink carrier being a downlink carrier activated between a terminal device and a base station.

In a second aspect, a terminal device is provided. The terminal includes a processor and a memory. The memory is configured to store a computer program, and the processor is configured to invoke and execute the computer program stored in the memory to perform the method according to the first aspect or implementations thereof.

### BRIEF DESCRIPTION OF THE DRAWINGS

FIG. 1 is a schematic architectural diagram of an NTN system according to an embodiment of the present disclosure.

FIG. 2 is a schematic architectural diagram of another NTN system according to an embodiment of the present disclosure.

FIG. 3 is a schematic architectural diagram of a communication system according to an embodiment of the present disclosure.

FIG. 4 is a schematic architectural diagram of another communication system according to an embodiment of the present disclosure.

FIG. 5 is a flowchart of a wireless communication method according to an embodiment of the present disclosure.

FIG. 6 is a schematic diagram of a target time offset according to an embodiment of the present disclosure.

FIG. 7 is a schematic diagram of a target time offset according to another embodiment of the present disclosure.

FIG. 8 is a schematic diagram of a target time offset according to yet another embodiment of the present disclosure.

FIG. 9 is a schematic diagram of a target time offset according to another embodiment of the present disclosure.

FIG. 10 shows a schematic block diagram of a terminal device 1000 according to an embodiment of the present disclosure.

FIG. 11 is a schematic structural diagram of a communication device 1100 according to an embodiment of the present disclosure.

FIG. 12 is a schematic structural diagram of an apparatus according to an embodiment of the present disclosure.

### DETAILED DESCRIPTION

Reference will be made to technical solutions in the embodiments of the present disclosure with accompanying drawings. Obviously, the embodiments described here are only part of the embodiments of the present disclosure and are not all embodiments of the present disclosure. Based on the embodiments of the present disclosure, other embodiments obtained by those skilled in the art without creative labor are within scope of the present disclosure.

Before introducing the technical solution of the present disclosure, relevant knowledge of the present disclosure is set forth below.

1. Related Background of NTN

At present, NTN technology is being researched in the 3rd Generation Partnership Project (3GPP). The NTN generally provides communication services to terrestrial users by means of satellite communication. Compared with terrestrial cellular network communication, the satellite communication has many unique advantages. First of all, the satellite communication is not limited by the area where a user is located. For example, general terrestrial communication cannot cover areas such as oceans, mountains, deserts, etc., where a communication device cannot be set up or communication coverage will not be provided due to sparse population. As far as the satellite communication is concerned, since a satellite can cover a great area of the ground and the satellite can orbit around the earth, theoretically every corner of the Earth can be covered by the satellite communication. Secondly, the satellite communication has great social value. For example, remote mountain areas, poor and laggard countries or areas can be covered by the satellite communication at a low cost, so that people in these areas can enjoy advanced voice communication and mobile internet technology, the digital gap between these areas and developed areas is favorably reduced, and the development of these areas is promoted. Thirdly, the communication distance of the satellite communication is great, and the communication cost does not increase significantly with the increase of communication distance. Finally, the satellite communication has high stability and is not limited by natural disasters.

Communication satellites are divided into Low-Earth Orbit (LEO) satellites, Medium-Earth Orbit (MEO) satellites, Geostationary Earth Orbit (GEO) satellites, High Elliptical Orbit (HEO) satellites, and the like, based on different orbital altitudes. At present, LEO and GEO are mainly studied.

LEO

An altitude of an LEO satellite ranges from 500 km to 1500 km, and a corresponding orbital period approximately ranges from 1.5 hours to 2 hours. A signal propagation delay of single-hop communication between users is generally small than 20 ms. A maximum satellite visual time is 20 minutes. A signal propagation distance is small, a link loss is less, and a transmission power of a user terminal is not required to be high.

GEO

An orbital altitude of a GEO satellite is 35786 km, and a rotation period around the Earth is 24 hours. A signal propagation delay of single-hop communication between users is generally 250 ms.

In order to ensure coverage of a satellite and improve system capacity of an entire satellite communication system, the satellite covers the ground with multiple beams, and the satellite can form dozens or even hundreds of beams to cover the ground, and a satellite beam can cover the ground area with a diameter of tens to hundreds of kilometers.

2. Fifth Generation (5G) NR DRX

In 5G NR, a network device can configure a DRX function for a terminal device, so that the terminal can monitor PDCCH discontinuously, so as to achieve a purpose of saving power for the terminal. In NR Release (Rel) 15, each Media Access Control (MAC) entity has a DRX configuration, and the configuration parameters for the DRX include the following.

Drx-onDurationTimer: a duration during which the terminal device is awake at the beginning of a DRX Cycle.

Drx-SlotOffset: a delay in the terminal device's initiating a drx-onDurationTimer.

Drx-InactivityTimer: a duration during which the terminal device continues to monitor the PDCCH in response to the terminal device receiving a PDCCH indicating an initial uplink transmission or an initial downlink transmission.

Drx-RetransmissionTimerDL: a maximum duration during which the terminal device monitors a PDCCH indicating downlink retransmission scheduling. Each downlink Hybrid Automatic Repeat Request (HARQ) process except a broadcast HARQ process corresponds to a drx-RetransmissionTimerDL.

Drx-RetransmissionTimerUL: a maximum duration during which the terminal device monitors a PDCCH indicating uplink retransmission scheduling. Each uplink HARQ process corresponds to a drx-RetransmissionTimerUL.

Drx-LongCycleStartOffset: drx-LongCycleStartOffset is used to configure a long DRX cycle, and a subframe offset between starts of the long DRX cycle and a short DRX cycle.

Drx-ShortCycle: Short DRX Cycle, which is an optional configuration.

Drx-ShortCycleTimer: a duration during which the terminal device is in the Short DRX Cycle and has not received any PDCCH, which is an optional configuration.

Drx-HARQ-RTT-TimerDL: a minimum waiting time required for the terminal device to expect to receive a PDCCH indicating downlink scheduling, and each downlink HARQ process except a broadcast HARQ process corresponds to a drx-HARQ-RTT-TimerDL.

Drx-HARQ-RTT-TimerUL: a minimum waiting time required for the terminal device to expect to receive a PDCCH indicating uplink scheduling, and each uplink HARQ process corresponds to a drx-HARQ-RTT-TimerUL.

When the terminal device is configured with DRX, the terminal device needs to monitor the PDCCH during the DRX Active Time. The DRX active time includes the following situations.

Any one of five timers, drx-onDurationTimer, drx-InactivityTimer, drx-RetransmissionTimerDL, drx-RetransmissionTimerUL, and ra-ContentionResolutionTimer, is running.

The SR is transmitted on the PUCCH and the SR is in a pending state.

In a contention-based random access process, the terminal device has not received an initial transmission indicated by a Cell-Radio Network Temporary Identifier (C-RNTI) scrambled PDCCH after successfully receiving the random access response.

3. 5G NR CA

In order to provide greater data transmission rate and improve user experience, 5G NR further increases the system bandwidth based on 4G. In 5G NR, for the frequency band below 6 GHz, a maximum bandwidth supported by a single carrier is 100 MHz; for the frequency band above 6 GHz, a maximum bandwidth supported by a single carrier is 400 MHz.

Like a Long Term Evolution (LTE) system, 5G NR also supports CA technology. For the terminal device supporting CA characteristics, the terminal device not only has a Primary Cell (PCell), but also the network device can configure one or more secondary cells (SCell) for the terminal through Radio Resource Control (RRC) signaling. SCell has an active state and an inactive state. Only when the SCell is in the active state, the terminal device can transmit and receive data on the SCell. The terminal can simultaneously monitor PDCCH and transmit and receive data on the PCell and one or more activated SCells, thereby improving the data transmission rate.

4. In NR Rel16, a DRX enhancement method is introduced for a scenario of CA between a Frequency Range (FR) 1 and an FR2. That is, two DRX packets can be configured for a MAC entity for a carrier corresponding to an FR1 and a carrier corresponding to an FR2, respectively. For DRX packet 2, the network device can configure a drx-InactivityTimer and a drx-onDurationTimer for it. That is, the remaining DRX configuration parameters are common to both DRX packets. Cross-carrier scheduling between two DRX packets is not currently supported.

5. 5G NR SR Process

The terminal device applies to the network device for uplink resources through an SR. The network device does not know when the terminal device needs to transmit uplink data, that is, the network device does not know when the terminal device will transmit the SR. Therefore, the network device may allocate to the terminal device periodic PUCCH resources for transmitting the SR, and then the network device detects whether there is an SR report on the allocated SR resources.

The SR in the NR may be based on a logical channel. For each uplink logical channel, the network device may choose whether to configure for that uplink logical channel a PUCCH resource for transmitting the SR. When an uplink logical channel for which the SR is triggered, if the network device configures for the uplink logical channel the PUCCH resource for transmitting the SR, the terminal device transmits the SR on the PUCCH resource for transmitting the SR corresponding to the logical channel. Otherwise, the terminal device initiates random access.

In NR Rel16, a mechanism of triggering an SR by Beam Failure Recovery (BFR) of an SCell is also introduced. When a terminal device triggers a BFR on a certain SCell, if the gauge terminal device has resources available for uplink new transmission and the available resources are sufficient to carry a BFR Media Access Control Element (MACE) or a Truncated BFR MAC CE, the terminal device informs the network that it has a beam failure on the SCell by transmitting a BFR MAC CE or a Truncated BFR MAC CE. Otherwise, the BFR triggers the SR.

The network device may configure a plurality of PUCCH resources for transmitting the SR for the terminal device. Each PUCCH configuration used for transmitting the SR corresponds to the following configuration parameters: 1. PUCCH resource cycle and time slot/time symbol offset; and 2. PUCCH resource index.

As described above, when the SR is transmitted on the PUCCH and the SR is in a pending state, the terminal device enters a DRX active time. In a scenario of CA between an FR1 and an FR2, two DRX packets are configured, and the terminal device will enter the DRX active time for the cells of these two DRX packets at the same time.

Compared with a TN, in an NTN, the signal transmission delay between a terminal device and a network device is greatly increased. From a point of view of terminal energy saving, it is necessary to introduce, for a case when the SR triggers terminal device to enter the DRX active time, a time offset determined based on RTT. As for a scenario of CA between the TN and the NTN, or a scenario of NTN CA with transparent forwarding by different satellites, there are great differences in signal transmission paths and time delays on different carriers between the terminal device and the TN, so how to determine the time offset is an urgent technical problem to be solved in the present disclosure.

In order to solve the above technical problem, the present disclosure can determine the time offset based on a transmission delay of the SR on the uplink carrier and a signal transmission delay on at least one downlink carrier.

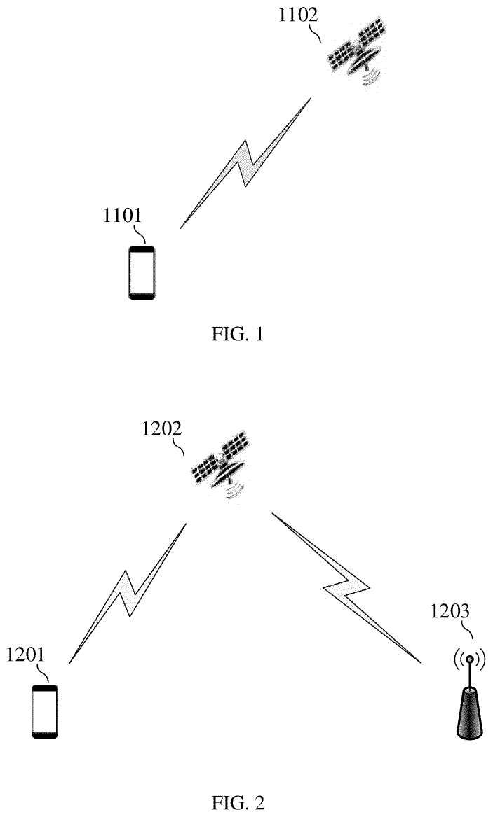

The architecture of an NTN system according to the present disclosure will be described below with reference to FIG. 1 and FIG. 2.

FIG. 1 is a schematic architectural diagram of an NTN system according to an embodiment of the present disclosure. Referring to FIG. 1, the NTN system includes a terminal device 1101 and a satellite 1102. Wireless communication may be performed between the terminal device 1101 and the satellite 1102. The network formed between the terminal device 1101 and the satellite 1102 may also be referred to as an NTN. In the architecture of the communication system shown in FIG. 1 the satellite 1102 may have a function of a base station and direct communication may be performed between the terminal device 1101 and the satellite 1102. In the system architecture, the satellite 1102 may be called a network device. Alternatively, a plurality of network devices 1102 may be included in the communication system and other numbers of terminal devices may be included within the coverage of each network device 1102, which is not limited by embodiments of the present disclosure.

FIG. 2 is a schematic architectural diagram of another NTN system according to an embodiment of the present disclosure. Referring to FIG. 2, the NTN system includes a terminal device 1201, a satellite 1202, and a base station 1203. Wireless communication may be performed between the terminal device 1201 and the satellite 1202, and communication may be performed between the satellite 1202 and the base station 1203. The network formed among the terminal device 1201, the satellite 1202 and the base station 1203 may also be referred to as an NTN. In the architecture of the communication system shown in FIG. 2, the satellite 1202 may not have a function of a base station and communication between the terminal device 1201 and the base station 1203 needs to be relayed through the satellite 1202. In this system architecture, the base station 1203 may be referred to as a network device. Alternatively, a plurality of network devices 1203 may be included in the communication system and other numbers of terminal devices may be included within the coverage of each network device 1203, which is not limited by embodiments of the present disclosure.

Optionally, the wireless communication system shown in FIG. 1 and FIG. 2 may also include other network entities, such as a Mobility Management Entity (MME), an Access and Mobility Management Function (AMF), and the like, which is not limited by the embodiments of the present disclosure.

It should be understood that the terms “system” and “network” are often used interchangeably herein.

The communication system to which the technical solution of the present disclosure can be applied is described below.

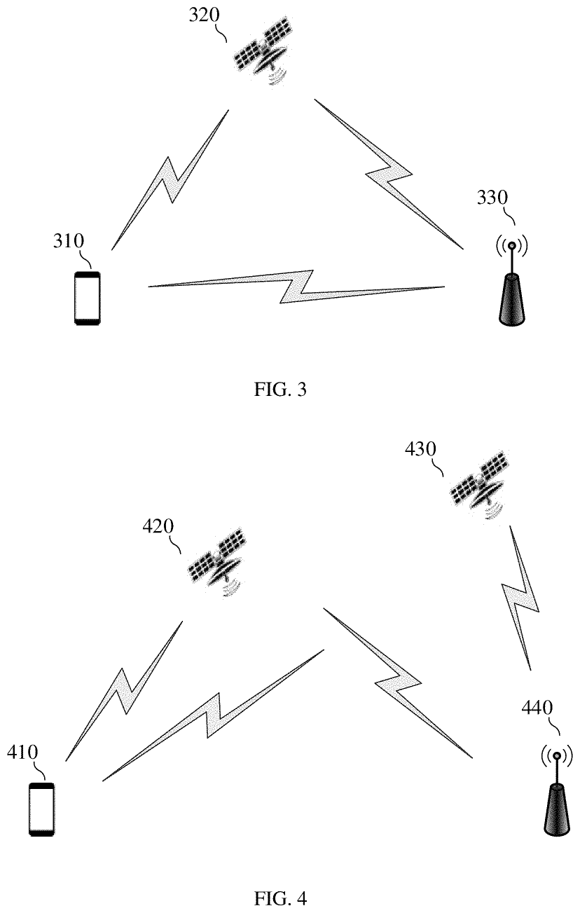

FIG. 3 is a schematic architectural diagram of a communication system according to an embodiment of the present disclosure. As shown in FIG. 3, the communication system includes a terminal device 310, a satellite 320, and a base station 330. Wireless communication may be performed between the terminal device 310 and the satellite 320, and may be performed between the satellite 320 and the base station 330, and may also be performed between the terminal device 310 and the base station 330.

It should be noted that the satellite 320 may not have a function of a base station and the communication between the terminal device 310 and the base station 330 may be relayed through the satellite 320. That is, the satellite 320 has a function of transparent forwarding. In this case, there are two transmission paths between the terminal device 310 and the base station 330, and a CA technology may be adopted for these two transmission paths. This is referred as a scenario of CA between a TN and an NTN.

Of course, the satellite 320 may also have the function of a base station. In this case, a Dual-Connectivity (DC) technology is adopted between the terminal device 310 and the satellite 320 and between the terminal device 310 and the base station 330. At the same time, there are two transmission paths between the terminal device 310 and the base station 330, and the CA technology may be adopted for these two transmission paths. This is referred as a scenario of a combination of DC and CA between a TN and an NTN.

FIG. 4 is a schematic architectural diagram of another communication system according to an embodiment of the present disclosure. As shown in FIG. 4, the communication system includes a terminal device 410, a satellite 420, a satellite 430, and a base station 440. Wireless communication may be performed between the terminal device 410 and the satellite 420, and may be performed between the terminal device 410 and the satellite 430, and may also be performed between the terminal device 410 and the base station 440.

It should be noted that the satellite 420 and the satellite 430 may not have a function of a base station, and the communication between the terminal device 410 and the base station 440 may be relayed through the satellite 420 and the satellite 430. That is, each of the satellite 420 and the satellite 430 has a function of transparent forwarding. In this case, there are two transmission paths between the terminal device 410 and the base station 440, and the CA technology may be adopted for these two transmission paths. This is referred as a scenario of NTN CA with transparent forwarding by different satellites.

Of course, the satellite 420 and the satellite 430 may also each have the function of a base station. In this case, a DC technology is adopted between the terminal device 410 and the satellite 420 and between the terminal device 410 and the satellite 430. At the same time, there are two transmission paths between the terminal device 410 and the base station 440, and the CA technology may be adopted for these two transmission paths. This is referred as a scenario of a combination of DC and CA between different NTNs.

It is should be mentioned that the technical solution of the present disclosure may be applied to an application scenario including: CA between a TN and an NTN; or NTN CA with transparent forwarding by different satellites.

Optionally, the technical solution of the present disclosure is applied in an application scenario including, but not limited to:

1. CA between a TN and an NTN;

2. NTN CA with transparent forwarding by different satellites;

3. a combination of Dual-Connectivity, DC, and CA between a TN and an NTN; or

4. a combination of DC and CA between different NTNs.

In embodiments of the present disclosure, the terminal device may also be referred to as a User Equipment (UE), an access terminal, a user unit, a user station, a mobile station, a mobile platform, a remote station, a remote terminal, a mobile device, a user terminal, a terminal, a wireless communication device, a user agent, or a user device, etc. The terminal device may be a STATION (ST) in the Wireless Local Area Network (WLAN), a cellular telephone, a cordless telephone, a Session Initiation Protocol (SIP) telephone, a Wireless Local Loop (WLL) station, a Personal Digital Assistant (PDA) device, a handheld device or a computing device having a wireless communication function, another processing device connected to a wireless modem, a vehicle-mounted device, a wearable device, and a next generation communication system, e.g., a terminal device in an NR network or a terminal device in a future evolved Public Land Mobile Network (PLMN) network, etc.

A wearable device can also be called a wearable intelligent device, and is a general term for wearable devices that are developed by using wearable technology to intelligently design daily necessities, such as glasses, gloves, wrist-watch, dress, and shoes. The wearable device may be worn directly on the body or may be a portable device integrated within the user's clothing or accessory. The wearable device is not only a hardware device, but also realizes powerful functions through software support, data interaction, and cloud interaction. In a broad sense, a wearable smart device may have full functions and a large size, and can realize complete or partial functions without depending on a smart phone, e.g. a smart watch or smart glasses and the like, or it may only focus on a certain type of application function and need to be used with another device (such as a smart phone), such as various smart bracelets for physical sign monitoring, smart jewelry, and the like.

In embodiments of the present disclosure, the terminal device can be deployed on the land, including indoor or outdoor, handheld, wearable or vehicle-mounted, and can also be deployed on the water surface (such as a ship and the like); and may also be deployed in the air (e.g., an airplane, a balloon, a satellite, etc.).

In embodiments of the present disclosure, the base station may be a Base Transceiver Station (BTS) in a Global System of Mobile communications (GSM) system or a Code Division Multiple Access (CDMA), may be a Node B (NB) in a Wideband Code Division Multiple Access (WCDMA), may be an Evolutional Node B (eNB, or eNodeB) in LTE, may be a gNB in an NR network, or may be a base station in a future evolved PLMN network, and the like.

In embodiments of the present disclosure, a base station may provide a service for a cell, and a terminal device communicates with the base station through a transmission resource (e.g., a frequency domain resource or a frequency spectrum resource) used by the cell. The cell may be a cell corresponding to the base station, and the cell may belong to a macro base station or a base station corresponding to a small cell. The small cell may include: a Metro cell, a Micro cell, a Pico cell, a Femto cell, and the like. The small cell has characteristics of small coverage area and low transmission power, and is suitable for providing high-rate data transmission services.

The technical solutions of the present disclosure will be described in detail below.

### Embodiment 1

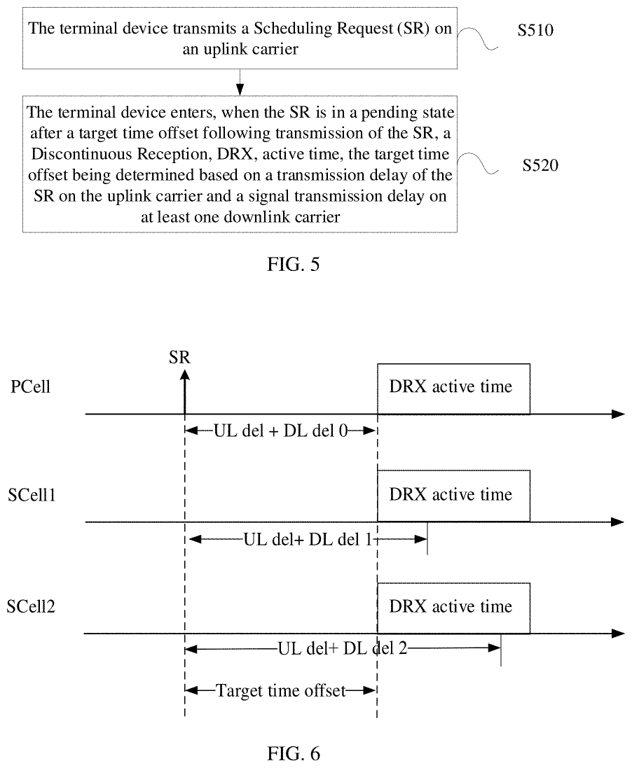

FIG. 5 is a flowchart of a wireless communication method according to an embodiment of the present disclosure. As shown in FIG. 5, the method includes the following.

At S510: the terminal device transmits a Scheduling Request (SR) on an uplink carrier.

At S520: the terminal device enters, when the SR is in a pending state after a target time offset following transmission of the SR, a Discontinuous Reception, DRX, active time. The target time offset is determined based on a transmission delay of the SR on the uplink carrier and a signal transmission delay on at least one downlink carrier.

It should be understood that the terminal device may receive, without limitation, configuration information such as a DRX-related parameter, an SCell-related parameter, an SR-related configuration, etc.

Optionally, the DRX related parameter may include, but are not limited to, one or more DRX packets configured for a MAC entity of the terminal device. For example, the DRX related parameter may also include: a configuration parameter of DRX as mentioned in related knowledge.

Optionally, when the DRX-related parameter includes a plurality of DRX packets configured for a MAC entity of the terminal device, the DRX-related parameter also includes a correspondence between each SCell and a DRX packet, each SCell corresponding to a DRX packet.

It is worth mentioning that a PCell corresponds to a default DRX packet.

Optionally, the SCell related parameter includes, but is not limited to, at least one SCell related parameter.

Optionally, the SR-related configuration includes, but is not limited to, a PUCCH resource for transmitting the SR.

Optionally, the configuration information may be carried in an RRC signaling, though this is not limiting.

Optionally, the target time offset is a time offset based on an end time of transmission of the SR.

It should be understood that, in the present disclosure, the time offset may also be described as a time bias, an offset, or a bias, or the like, which is not limited herein.

It should be understood that the at least one downlink carrier is an active downlink carrier between the terminal device and the base station.

To sum up, in the present disclosure, the terminal device enters, when the SR is in the pending state after the target time offset following transmission of the SR, the DRX active time, the target time offset being determined based on the transmission delay of the SR on the uplink carrier and the signal transmission delay on at least one downlink carrier. The technical solution according to the present disclosure can determine the target time offset even when the signal transmission paths and time delays on different carriers between the terminal device and the TN are quite different. It can not only ensure scheduling performance, but also desirably take into account a demand of terminal energy saving.

The following will describe the technical solutions of the present disclosure in detail for different configurations for DRX packets and for maintenance of the DRX active time by a terminal device.

### Embodiment 2

This embodiment is for a situation when one DRX packet is configured for a MAC entity, and DRX active times are maintained by the terminal device uniformly for the MAC entity.

It should be understood that the terminal device may receive, without limitation, configuration information such as a DRX-related parameter, an SCell-related parameter, an SR-related configuration, etc.

Optionally, the DRX related parameter may include, but is not limited to, one DRX packet configured for a MAC entity of the terminal device. For example, the DRX related parameter may also include: a configuration parameter of DRX as mentioned in related knowledge.

Optionally, the SCell related parameter includes, but is not limited to, at least one SCell related parameter.

Optionally, the SR-related configuration includes, but is not limited to, a PUCCH resource for transmitting the SR.

Optionally, the configuration information may be carried in an RRC signaling, though this is not limiting.

Optionally, the target time offset is determined based on the transmission delay of the SR on the uplink carrier and a first signal transmission delay. The first signal transmission delay is a minimum one of signal transmission delays on all activated downlink carriers in a cell group where the uplink carrier is located. Said all activated downlink carriers are downlink carriers between the terminal device and the base station.

Optionally, the target time offset is a sum of the transmission delay of the SR on the uplink carrier and the first signal transmission delay.

Assuming that the target time offset is represented by offset, the transmission delay of the SR on the uplink carrier is represented by UL del, and the signal transmission delay on the downlink carrier is represented by DL del, the offset can be determined by the following equation (1):

offset=UL del+min {DL del n,(n=1,2, . . . N)} (1),

where DL del n represents the signal transmission delay on the downlink carrier n, min {DL del n, (n=1, 2, . . . N)} represents the first signal transmission delay, and N represents the number of all activated downlink carriers in the cell group where the uplink carrier on which the terminal device transmits the SR is located. In a scenario of a combination of DC and CA between a TN and an NTN, or in a scenario of a combination of DC and CA between different NTNs, the cell group where the uplink carrier is located may be a Master Cell Group (MCG) or a Secondary Cell Group (SCG).

Optionally, the target time offset may also be greater than a sum of the transmission delay of the SR on the uplink carrier and the first signal transmission delay.

Exemplarily, FIG. 6 is a schematic diagram of the target time offset according to an embodiment of the present disclosure. As shown in FIG. 6, one DRX packet is configured for a MAC entity, and DRX active times are maintained by the terminal device uniformly for the MAC entity. For a PCell, an RTT between the terminal device and the base station on the downlink carrier corresponding to PCell is UL del+DL del 0, where DL del 0 represents the signal transmission delay on the downlink carrier corresponding to the PCell. For an SCell 1, an RTT between the terminal device and the base station on the downlink carrier corresponding to the SCell 1 is UL del+DL del 1, where DL del 1 represents the signal transmission delay on the downlink carrier corresponding to the SCell 1. For an SCell 2, an RTT between the terminal device and the base station on the downlink carrier corresponding to the SCell 2 is UL del+DL del 2, where DL del 2 represents the signal transmission delay on the downlink carrier corresponding to the SCell 2. Based on the above solution, it can be determined that the target time offset is UL del+DL del 0.

To sum up, in the present disclosure, when one DRX packet is configured for the MAC entity, and the DRX active times are maintained by the terminal device uniformly for the MAC entity, the target time offset is determined based on the transmission delay of the SR on the uplink carrier and the first signal transmission delay. The technical solution according to the present disclosure can determine the target time offset even when the signal transmission paths and time delays on different carriers between the terminal device and the TN are quite different. It can not only ensure scheduling performance, but also desirably take into account a demand of terminal energy saving.

### Embodiment 3

This embodiment is for a situation when one DRX packet is configured for a MAC entity, and DRX active times are maintained by the terminal device separately for individual serving cells corresponding to the MAC entity.

It should be understood that the terminal device may receive, without limitation, configuration information such as a DRX-related parameter, an SCell-related parameter, an SR-related configuration, etc.

Optionally, the DRX related parameter may include, but is not limited to, one DRX packet configured for a MAC entity of the terminal device. For example, the DRX related parameter may also include: a configuration parameter of DRX as mentioned in related knowledge.

Optionally, the SCell related parameter includes, but is not limited to, at least one SCell related parameter.

Optionally, the SR-related configuration includes, but is not limited to, a PUCCH resource for transmitting the SR.

Optionally, the configuration information may be carried in an RRC signaling, though this is not limiting.

Optionally, the target time offset is determined, for any one of the individual serving cells, based on the transmission delay of the SR on the uplink carrier and a signal transmission delay on a downlink carrier corresponding to the serving cell. The downlink carrier corresponding to the serving cell is a downlink carrier between the terminal device and the base station.

Optionally, the target time offset is a sum of the transmission delay of the SR on the uplink carrier and the signal transmission delay on the downlink carrier corresponding to the serving cell.

Assuming that the target time offset is represented by offset, the transmission delay of the SR on uplink carrier is represented by UL del, and the signal transmission delay on the downlink carrier corresponding to the serving cell n is represented by DL del n, n=1, 2, . . . N, N represents the number of downlink carriers currently activated in the cell group where the uplink carrier on which the terminal device transmits the SR is located. In the scenario of the combination of DC and CA between the TN and the NTN, or the scenario of the combination of DC and CA between different NTNs, the cell group where the uplink carrier is located can be an MCG or an SCG. Then offset can be determined by the following equation (2):

offset=UL del+DL del n (2).

Optionally, the target time offset may also be greater than the sum of the transmission delay of the SR on the uplink carrier and the signal transmission delay on the downlink carrier corresponding to the serving cell.

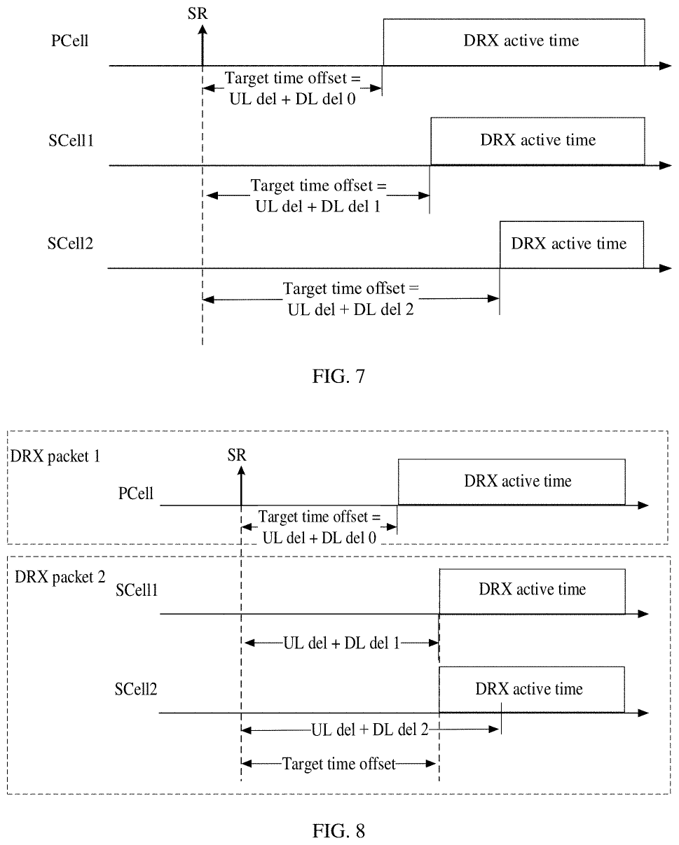

Exemplarily, FIG. 7 is a schematic diagram of a target time offset according to another embodiment of the present disclosure. As shown in FIG. 7, one DRX packet is configured for a MAC entity, and DRX active times are maintained by the terminal device separately for individual serving cells corresponding to the MAC entity. For a PCell, an RTT between the terminal device and the base station on the downlink carrier corresponding to PCell is UL del+DL del 0, where DL del 0 represents the signal transmission delay on the downlink carrier corresponding to the PCell. Based on the above solution, it can be determined that the target time offset corresponding to the PCell is UL del+DL del 0. For an SCell 1, the RTT between the terminal device and the base station on the downlink carrier corresponding to the SCell 1 is UL del+DL del 1, where DL del 1 represents the signal transmission delay on the downlink carrier corresponding to the SCell 1. Based on the above solution, it can be determined that the target time offset corresponding to the SCell1 is UL del+DL del 1. For an SCell 2, an RTT between the terminal device and the base station on the downlink carrier corresponding to the SCell 2 is UL del+DL del 2, where DL del 2 represents the signal transmission delay on the downlink carrier corresponding to the SCell 2. Based on the above solution, it can be determined that the target time offset corresponding to the SCell2 is UL del+DL del 2.

To sum up, in the present disclosure, when one DRX packet is configured for a MAC entity, and the DRX active times are maintained by the terminal device separately for individual serving cells corresponding to the MAC entity, the target time offset is determined based on the transmission delay of the SR on the uplink carrier and the signal transmission delay on the downlink carrier corresponding to the serving cell. The technical solution according to the present disclosure can determine the target time offset even when the signal transmission paths and time delays on different carriers between the terminal device and the TN are quite different. It can not only ensure scheduling performance, but also desirably take into account a demand of terminal energy saving.

### Embodiment 4

This embodiment is for a situation when a plurality of DRX packets is configured for a MAC entity and DRX active times are maintained by the terminal device separately for the plurality of DRX packets.

It should be understood that the terminal device may receive, without limitation, configuration information such as a DRX-related parameter, an SCell-related parameter, an SR-related configuration, etc.

Optionally, the DRX related parameter may include, but is not limited to, a plurality of DRX packets configured for a MAC entity of the terminal device. For example, DRX related parameter may also include: a configuration parameter of DRX as mentioned in related knowledge.

Optionally, when the DRX-related parameter includes a plurality of DRX packets configured for a MAC entity of the terminal device, the DRX-related parameter also includes a correspondence between each SCell and a DRX packet, each SCell corresponding to a DRX packet.

It is worth mentioning that a PCell corresponds to a default DRX packet.

Optionally, the SCell related parameter includes, but is not limited to, at least one SCell related parameter.

Optionally, the SR-related configuration includes, but is not limited to, a PUCCH resource for transmitting the SR.

Optionally, the configuration information may be carried in an RRC signaling, though this is not limiting.

Optionally, in the present embodiment, the target time offset is determined, for any one of the plurality of DRX packets, based on the transmission delay of the SR on the uplink carrier and a second signal transmission delay. The second signal transmission delay is a minimum one of signal transmission delays on all activated downlink carriers corresponding to the DRX packet. Said all downlink active carriers are downlink carriers between the terminal device and the base station.

It should be understood that the above-mentioned any one of the plurality of DRX packets is any one of the plurality of DRX packets in the cell group where the uplink carrier for transmitting the SR is located. In the scenario of the combination of DC and CA between the TN and the NTN, or the scenario of the combination of DC and CA between different NTNs, the cell group where the uplink carrier is located can be an MCG or an SCG.

Optionally, the target time offset is a sum of the transmission delay of the SR on the uplink carrier and the second signal transmission delay.

Assuming that the target time offset corresponding to the DRX packet m is represented by offset m, the transmission delay of the SR on the uplink carrier is represented by UL del, and in a DRX packet m, the signal transmission delay on the downlink carrier corresponding to the serving cell n is represented by DL del n, n=1, 2, . . . N, and N represents the number of currently activated downlink carriers corresponding to the DRX packet m, then offset m can be determined by the following equation (3):

offset m=UL del+min {DL del n,(n=1,2, . . . N)} (3).

Optionally, the target time offset may also be greater than the sum of the transmission delay of the SR on the uplink carrier and the second signal transmission delay.

Exemplarily, FIG. 8 is a schematic diagram of a target time offset according to yet another embodiment of the present disclosure. As shown in FIG. 8, a plurality of DRX packets is configured for a MAC entity, DRX active times are maintained by the terminal device separately for the plurality of DRX packets. A PCell corresponds to a DRX packet 1, and an SCell 1 and an SCell 2 correspond to a DRX packet 2. For the PCell, an RTT between the terminal device and the base station on the downlink carrier corresponding to PCell is UL del+DL del 0, where DL del 0 represents the signal transmission delay on the downlink carrier corresponding to the PCell. Based on the above solution, it can be determined that the target time offset corresponding to the DRX packet 1 is UL del+DL del 0. For an SCell 1, an RTT between the terminal device and the base station on the downlink carrier corresponding to the SCell 1 is UL del+DL del 1, where DL del 1 represents the signal transmission delay on the downlink carrier corresponding to the SCell 1. For an SCell 2, an RTT between the terminal device and the base station on the downlink carrier corresponding to the SCell 2 is UL del+DL del 2, where DL del 2 represents the signal transmission delay on the downlink carrier corresponding to the SCell 2. Based on the above solution, it can be determined that the target time offset corresponding to the DRX packet 2 is UL del+DL del 1.

To sum up, in the present disclosure, when the plurality of DRX packets is configured for the MAC entity, the DRX active times are maintained by the terminal device separately for the plurality of DRX packets, the target time offset is determined based on the transmission delay of the SR on the uplink carrier and the second signal transmission delay. The technical solution according to the present disclosure can determine the target time offset even when the signal transmission paths and time delays on different carriers between the terminal device and the TN are quite different. It can not only ensure scheduling performance, but also desirably take into account a demand of terminal energy saving.

### Embodiment 5

This embodiment is for a situation a plurality of DRX packets is configured for a MAC entity, DRX active times are maintained by the terminal device separately for the plurality of DRX packets, and cross-carrier scheduling on carriers corresponding to different DRX packets is not supported by the terminal device.

It should be understood that the terminal device may receive, without limitation, configuration information such as a DRX-related parameter, an SCell-related parameter, an SR-related configuration, etc.

Optionally, the DRX related parameter may include, but is not limited to, a plurality of DRX packets configured for a MAC entity of the terminal device. For example, DRX related parameter may also include: a configuration parameter of DRX as mentioned in related knowledge.

Optionally, when the DRX-related parameter includes a plurality of DRX packets configured for a MAC entity of the terminal device, the DRX-related parameter also includes a correspondence between each SCell and a DRX packet, each SCell corresponding to a DRX packet.

It is worth mentioning that a PCell corresponds to a default DRX packet.

Optionally, the SCell related parameter includes, but is not limited to, at least one SCell related parameter.

Optionally, the SR-related configuration includes, but is not limited to, a PUCCH resource for transmitting the SR.

Optionally, the configuration information may be carried in an RRC signaling, though this is not limiting.

Optionally, in the present embodiment, the target time offset is determined, for a first DRX packet in the plurality of DRX packets, based on the transmission delay of the SR on the uplink carrier and a third signal transmission delay. The first DRX packet is a DRX packet meeting a predetermined condition among the plurality of DRX packets, and the third signal transmission delay is a minimum one of signal transmission delays on all activated downlink carriers corresponding to the first DRX packet, said all activated downlink carriers are downlink carriers between the terminal device and the base station. Alternatively, the third signal transmission delay is a minimum one of the signal transmission delays on a set of first downlink carriers corresponding to the first DRX packet. The set of first downlink carriers is a set of downlink carriers corresponding to a set of first uplink carriers determined based on cross-carrier scheduling configuration. The set of first uplink carriers is a set of uplink carriers on which an uplink logical channel can be transmitted, which is determined based on a Link Control Protocol (LCP) restriction of the uplink logical channel for which the SR is triggered. The set of first uplink carriers corresponds to the first DRX packet.

It should be understood that the plurality of DRX packets mentioned above is the plurality of DRX packets in the cell group where the uplink carrier for transmitting the SR is located. In the scenario of the combination of DC and CA between the TN and the NTN, or the scenario of the combination of DC and CA between different NTNs, the cell group where the uplink carrier is located can be an MCG or an SCG.

Optionally, the target time offset is a sum of the transmission delay of the SR on the uplink carrier and the third signal transmission delay.

Optionally, the predetermined condition includes, but is not limited to, that the SR is triggered by a regular Buffer Status Report (BSR) triggered for the uplink logical channel, and the uplink logical channel is determined, based on a Link Control Protocol (LCP) restriction of the uplink logical channel, to be allowed to be transmitted on at least one serving cell corresponding to the first DRX packet.

The LCP restriction is not limited in the present disclosure, and how to determine, based on the LCP restriction, whether the uplink logical channel is allowed to be transmitted on at least one serving cell corresponding to the first DRX packet is not limited.

Optionally, the predetermined condition includes, but is not limited to, that the SR is triggered by an event other than a regular BSR triggered for an uplink logical channel.

Assuming that the DRX packet m is a DRX packet meeting the predetermined condition, the corresponding target time offset is represented by offset m, the transmission delay of the SR on the uplink carrier is represented by UL del, and in the DRX packet m, the signal transmission delay on the downlink carrier corresponding to the serving cell n is represented by DL del n, n=1, 2, . . . N, and N represents the number of currently activated downlink carriers corresponding to the DRX packet m, then the offset m can be determined by the following equation (4):

offset m=UL del+min{DL del n,(n=1,2, . . . N)} (4).

Optionally, the target time offset may also be greater than a sum of the transmission delay of the SR on the uplink carrier and the third signal transmission delay.

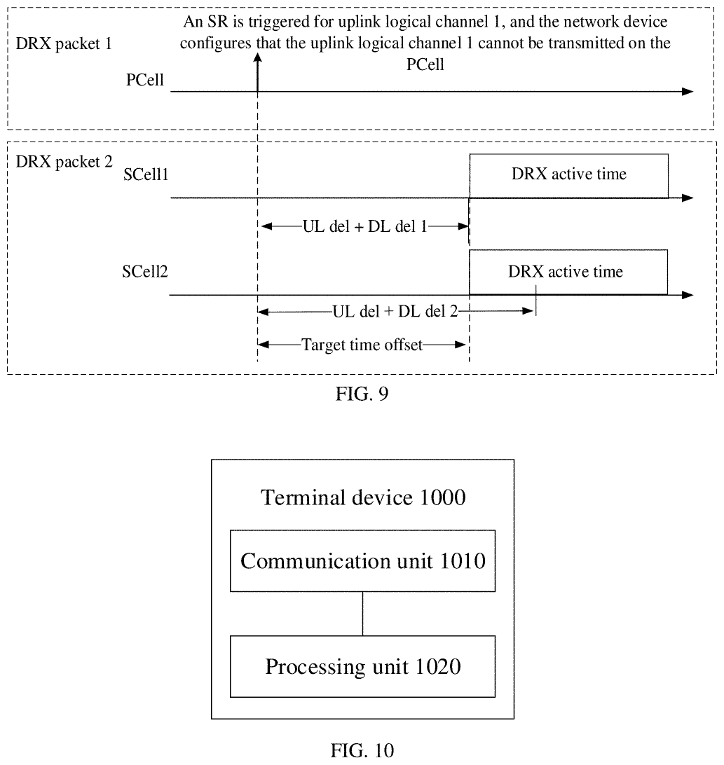

Exemplarily, FIG. 9 is a schematic diagram of a target time offset according to yet another embodiment of the present disclosure. As shown in FIG. 9, a plurality of DRX packets is configured for a MAC entity, DRX active times are maintained by the terminal device separately for the plurality of DRX packets, and cross-carrier scheduling on carriers corresponding to different DRX packets is not supported by the terminal device. A PCell corresponds to a DRX Packet 1, an SCell 1 and an SCell 2 correspond to a DRX Packet 2. Since an SR is triggered for an uplink logical channel 1 and the network device configures that the uplink logical channel 1 cannot be transmitted on the PCell, the DRX Packet 1 does not meet the predetermined condition. Based on this, there is no need to determine the target time offset corresponding to the DRX Packet 1. On the contrary, the DRX Packet 2 meets the predetermined condition described above. Based on this, it is necessary to determine the target time offset corresponding to the DRX Packet 2. The details are as follows: For the SCell 1, an RTT between the terminal device and the base station on the downlink carrier corresponding to the SCell 1 is UL del+DL del 1, where DL del 1 represents the signal transmission delay on the downlink carrier corresponding to the SCell 1. For the SCell 2, an RTT between the terminal device and the base station on the downlink carrier corresponding to the SCell 2 is UL del+DL del 2, where DL del 2 represents the signal transmission delay on the downlink carrier corresponding to the SCell 2. Based on the above solution, it can be determined that the target time offset corresponding to the DRX packet 2 is UL del+DL del 1.

To sum up, in the present disclosure, when the plurality of DRX packets is configured for the MAC entity, the DRX active times are maintained by the terminal device separately for the plurality of DRX packets, and the cross-carrier scheduling on carriers corresponding to different DRX packets is not supported by the terminal device, the target time offset is determined based on the transmission time delay of the SR on the uplink carrier and the third signal transmission delay. The technical solution according to the present disclosure can determine the target time offset even when the signal transmission paths and time delays on different carriers between the terminal device and the TN are quite different. It can not only ensure scheduling performance, but also desirably take into account a demand of terminal energy saving.

The method embodiments of the present disclosure have been described in detail above with reference to FIG. 5 to FIG. 9, and the apparatus embodiments of the present disclosure are described in detail below with reference to FIG. 10 to FIG. 12. It should be understood that the apparatus embodiments and the method embodiments correspond to each other, and similar descriptions may refer to the method embodiments.

FIG. 10 shows a schematic block diagram of a terminal device 1000 according to an embodiment of the present disclosure. As shown in FIG. 10 the terminal device 1000 includes a communication unit 1010 and a processing unit 1020. The communication unit 1010 is configured to transmit an SR on an uplink carrier. The processing unit 1020 is configured to enter, when the SR is in a pending state after a target time offset following transmission of the SR, a DRX active time. The target time offset is determined based on a transmission delay of the SR on the uplink carrier and a signal transmission delay on at least one downlink carrier. At least one downlink carrier is a downlink carrier activated between a terminal device and a base station.

Optionally, the terminal device is applied in an application scenario including: CA between a TN and a NTN, or NTN CA with transparent forwarding by different satellites.

Optionally, the application scenario is any one of: CA between a TN and an NTN; NTN CA with transparent forwarding by different satellites; a combination of DC and CA between a TN and an NTN; or a combination of DC and CA between different NTNs.

Optionally, when one DRX packet is configured for a MAC entity, and DRX active times are maintained by the terminal device uniformly for the MAC entity, the target time offset is determined based on the transmission delay of the SR on the uplink carrier and a first signal transmission delay. The first signal transmission delay is a minimum one of signal transmission delays on all activated downlink carriers in a cell group where the uplink carrier is located, said all activated downlink carriers being downlink carriers between the terminal device and the base station.

Optionally, the target time offset is a sum of the transmission delay of the SR on the uplink carrier and the first signal transmission delay.

Optionally, the target time offset is greater than a sum of the transmission delay of the SR on the uplink carrier and the first signal transmission delay.

Optionally, when one DRX packet is configured for a MAC entity, and DRX active times are maintained by the terminal device separately for individual serving cells corresponding to the MAC entity, the target time offset is determined, for any one of the individual serving cells, based on the transmission delay of the SR on the uplink carrier and a signal transmission delay on a downlink carrier corresponding to the serving cell. The downlink carrier corresponding to the serving cell is a downlink carrier between the terminal device and the base station.

Optionally, the target time offset is a sum of the transmission delay of the SR on the uplink carrier and the signal transmission delay on the downlink carrier corresponding to the serving cell.

Optionally, the target time offset is greater than a sum of the transmission delay of the SR on the uplink carrier and the signal transmission delay on the downlink carrier corresponding to the serving cell.

Optionally, when a plurality of DRX packets is configured for a MAC entity, and DRX active times are maintained by the terminal device separately for the plurality of DRX packets, the target time offset is determined, for any one of the plurality of DRX packets, based on the transmission delay of the SR on the uplink carrier and a second signal transmission delay. The second signal transmission delay is a minimum one of signal transmission delays on all activated downlink carriers corresponding to the DRX packet, said all activated downlink carriers being downlink carriers between the terminal device and the base station.

Optionally, the target time offset is a sum of the transmission delay of the SR on the uplink carrier and the second signal transmission delay.

Optionally, the target time offset is greater than a sum of the transmission delay of the SR on the uplink carrier and the second signal transmission delay.

Optionally, when a plurality of DRX packets is configured for a MAC entity, DRX active times are maintained by the terminal device separately for the plurality of DRX packets, and cross-carrier scheduling on carriers corresponding to different DRX packets is not supported by the terminal device, the target time offset is determined, for a first DRX packet in the plurality of DRX packets, based on the transmission delay of the SR on the uplink carrier and a third signal transmission delay. The first DRX packet is a DRX packet meeting a predetermined condition among the plurality of DRX packets, and the third signal transmission delay is a minimum one of signal transmission delays on all activated downlink carriers corresponding to the first DRX packet, said all activated downlink carriers being downlink carriers between the terminal device and the base station.

Optionally, the target time offset is a sum of the transmission delay of the SR on the uplink carrier and the third signal transmission delay.

Optionally, the target time offset is greater than a sum of the transmission delay of the SR on the uplink carrier and the third signal transmission delay.

Optionally, the predetermined condition includes that the SR is triggered by a regular BSR triggered for an uplink logical channel. The uplink logical channel is determined, based on an LCP restriction of the uplink logical channel, to be allowed to be transmitted on at least one serving cell corresponding to the first DRX packet.

Optionally, the predetermined condition includes that the SR is triggered by an event other than a regular BSR triggered for an uplink logical channel.

Optionally, in some embodiments of the present disclosure, the communication unit may be a communication interface, or a transceiver, or an input-output interface of a communication chip or a system-on-chip. The processing unit may be one or more processors.

It should be understood that the terminal device 1000 according to the embodiment of the present disclosure may correspond to the terminal device according to the method embodiments of the present disclosure, and that the above and other operations and/or functions of the individual units in the terminal device 1000 are for implementing the corresponding flow of the terminal device in the method shown in FIG. 5, respectively, which will not repeated here for the sake of brevity.

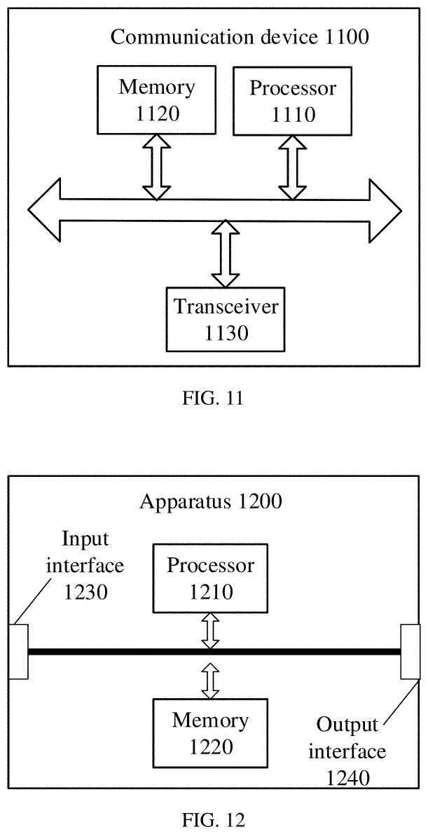

FIG. 11 is a schematic structural diagram of a communication device 1100 according to an embodiment of the present disclosure. The communication device 1100 shown in FIG. 11 includes a processor 1110. The processor 1110 may invoke and run a computer program stored in a memory to perform the method according to an embodiment of the present disclosure.

Optionally, as shown in FIG. 11, the communication device 1100 may also include a memory 1120. The processor 1110 may invoke and run a computer program stored in the memory 1120 to perform the method according to an embodiment of the present disclosure.

The memory 1120 may be a separate device independent of the processor 1110 or may be integrated with in the processor 1110.

Optionally, as shown in FIG. 11, the communication device 1100 may also include a transceiver 1130. The processor 1110 may control the transceiver 1130 to communicate with other devices and in particular may transmit information or data to or receive information or data transmitted by other devices.

The transceiver 1130 may include a transmitter and a receiver. The transceiver 1130 may further include one or more antennas.

Optionally, the communication device 1100 may specifically be a terminal device according to an embodiment of the present disclosure, and the communication device 1100 may implement corresponding processes implemented by the terminal device in each method according to the embodiment of the present disclosure, which will not be repeated here for the sake of brevity.

FIG. 12 is a schematic structural diagram of an apparatus according to an embodiment of the present disclosure. The apparatus 1200 shown in FIG. 12 includes a processor 1210. The processor 1210 may invoke and run a computer program store in a memory to implement the method according to an embodiment of the present disclosure.

Optionally, as shown in FIG. 12, the device 1200 may also include a memory 1220. The processor 1210 may invoke and run a computer program stored in the memory 1220 to implement the method according to an embodiment of the present disclosure.

The memory 1220 may be a separate device independent of the processor 1210 or may be integrated within the processor 1210.

Optionally, the apparatus 1200 may also include an input interface 1230. The processor 1210 may control the input interface 1230 to communicate with other devices or chips and in particular may obtain information or data transmitted by other devices or chips.

Optionally, the apparatus 1200 may also include an output interface 1240. The processor 1210 may control the output interface 1240 to communicate with other devices or chips and in particular may output information or data to other devices or chips.

Optionally, the apparatus can be applied to the terminal device according to the embodiment of the present disclosure, and the apparatus can implement the corresponding processes implemented by the terminal device in the respective methods according to the embodiment of the present disclosure, which will not be repeated here for the sake of brevity.

Optionally, the device mentioned in the embodiment of the present disclosure may also be a chip. For example, the chip may also be referred to as a system-level chip, a system-chip, a chip system, or a system-on-chip.

It is to be noted that the processor in the embodiment of the present disclosure may be an integrated circuit chip with signal processing capability. In an implementation, the steps of the above method embodiments can be implemented by hardware integrated logic circuits in a processor or instructions in the form of software. The processor can be a general purpose processor, a Digital Signal Processor (DSP), an Application Specific Integrated Circuit (ASIC), a Field Programmable Gate Array (FPGA) or another programmable logic device, a discrete gate or transistor logic device, or a discrete hardware component. The methods, steps, and logical block diagrams disclosed in the embodiments of the present disclosure can be implemented or performed. The general purpose processor may be a microprocessor or any conventional processor. The steps of the methods disclosed in the embodiments of the present disclosure may be directly embodied as being performed and completed by a hardware decoding processor, or by a combination of hardware and software modules in the decoding processor. The software modules can be located in a known storage medium in the related art, such as random access memory, flash memory, read-only memory, programmable read-only memory, electrically erasable programmable memory, or register. The storage medium can be located in the memory, and the processor can read information from the memory and perform the steps of the above methods in combination with its hardware.

It can be appreciated that the memory in the embodiments of the present disclosure may be a volatile memory or a non-volatile memory, or may include both volatile and non-volatile memories. Here, the non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), which is used as an external cache. As illustrative, rather than limiting, examples, many forms of RAMs are available, including Static RAM (SRAM), Dynamic RAM (DRAM), Synchronous DRAM (SDRAM), Double Data Rate SDRAM (DDR SDRAM), Enhanced SDRAM (ESDRAM), Synchlink DRAM (SLDRAM)), and Direct Rambus RAM (DR RAM). It is to be noted that the memory used for the system and method described in the present disclosure is intended to include, but not limited to, these and any other suitable types of memories.

It can be appreciated that the above memories are exemplary only, rather than limiting the present disclosure. For example, the memory in the embodiment of the present disclosure may also be a Static RAM (SRAM), a Dynamic RAM (DRAM), a Synchronous DRAM (SDRAM), a Double Data Rate SDRAM (DDR SDRAM), an Enhanced SDRAM (ESDRAM), a Synch Link DRAM (SLDRAM), or a Direct Rambus RAM (DR RAM). That is, the memory in the embodiments of the present disclosure is intended to include, but not limited to, these and any other suitable types of memories.

An embodiment of the present disclosure also provides a computer readable storage medium for storing a computer program.

Optionally, the computer readable storage medium can be applied to the network device or the base station in the embodiment of the present disclosure, and the computer program can cause a computer to perform corresponding procedures implemented by the network device or the base station in the method according to any of the embodiments of the present disclosure. Details thereof will be omitted here for simplicity.

Optionally, the computer readable storage medium can be applied to the mobile terminal/terminal device in the embodiment of the present disclosure, and the computer program can cause a computer to perform corresponding procedures implemented by the mobile terminal/terminal device in the method according to any of the embodiments of the present disclosure. Details thereof will be omitted here for simplicity.

An embodiment of the present disclosure also provides a computer program product including computer program instructions.

Optionally, the computer program product can be applied to the network device or the base station in the embodiment of the present disclosure, and the computer program instructions can cause a computer to perform corresponding procedures implemented by the network device or the base station in the method according to any of the embodiments of the present disclosure. Details thereof will be omitted here for simplicity.

Optionally, the computer program product can be applied to the mobile terminal/terminal device in the embodiment of the present disclosure, and the computer program instructions can cause a computer to perform corresponding procedures implemented by the mobile terminal/terminal device in the method according to any of the embodiments of the present disclosure. Details thereof will be omitted here for simplicity.

An embodiment of the present disclosure also provides a computer program.

Optionally, the computer program can be applied to the network device or the base station in the embodiment of the present disclosure. The computer program, when executed on a computer, can cause the computer to perform corresponding procedures implemented by the network device or the base station in the method according to any of the embodiments of the present disclosure. Details thereof will be omitted here for simplicity.

Optionally, the computer program can be applied to the mobile terminal/terminal device in the embodiment of the present disclosure. The computer program, when executed on a computer, can cause the computer to perform corresponding procedures implemented by the mobile terminal/terminal device in the method according to any of the embodiments of the present disclosure. Details thereof will be omitted here for simplicity.

It can be appreciated by those skilled in the art that units and algorithm steps in the examples described in connection with the embodiments disclosed herein can be implemented in electronic hardware or any combination of computer software and electronic hardware. Whether these functions are executed by hardware or software depends on specific applications and design constraint conditions of the technical solutions. Those skilled in the art may use different methods for each specific application to implement the described functions, and such implementation is to be encompassed by the scope of this disclosure.

Those skilled in the art can clearly understand that, for the convenience and conciseness of the description, for the specific operation processes of the systems, devices, and units described above, reference can be made to the corresponding processes in the foregoing method embodiments, and details thereof will be omitted here.

In the embodiments of the present disclosure, it can be appreciated that the disclosed systems, devices, and methods may be implemented in other ways. For example, the device embodiments described above are illustrative only. For example, the divisions of the units are only divisions based on logical functions, and there may be other divisions in actual implementations. For example, more than one unit or component may be combined or integrated into another system, or some features can be ignored or omitted. In addition, the mutual coupling or direct coupling or communicative connection as shown or discussed may be indirect coupling or communicative connection between devices or units via some interfaces which may be electrical, mechanical, or in any other forms.

The units described as separate components may or may not be physically separated, and the components shown as units may or may not be physical units, that is, they may be co-located or distributed across a number of network elements. Some or all of the units may be selected according to actual needs to achieve the objects of the solutions of the embodiments.

In addition, the functional units in the embodiments of the present disclosure may be integrated into one processing unit, or alternatively be separate physical modules, or two or more units may be integrated into one unit.

When the function is implemented in the form of a software functional unit and sold or used as a standalone product, it can be stored in a computer readable storage medium. Based on this understanding, all or part of the technical solutions according to the embodiments of the present disclosure, or the part thereof that contributes to the prior art, can be embodied in the form of a software product. The computer software product may be stored in a storage medium and include instructions to enable a computer device, such as a personal computer, a server, or a network device, etc., to perform all or part of the steps of the method described in each of the embodiments of the present disclosure. The storage medium may include a Universal Serial Bus flash drive, a mobile hard disk, a Read-Only Memory (ROM), a Random Access Memory (RAM), a magnetic disk, an optical disc, or any other medium capable of storing program codes.

While the specific embodiments of the present disclosure have been described above, the scope of the present disclosure is not limited to these embodiments. Various variants and alternatives can be made by those skilled in the art without departing from the scope of the present disclosure. These variants and alternatives are to be encompassed by the scope of present disclosure as defined by the claims as attached.

What is claimed is:

1. A wireless communication method, comprising:
transmitting a Scheduling Request, SR, on an uplink carrier; and
entering, when the SR is in a pending state after a target time offset following transmission of the SR, a Discontinuous Reception, DRX, active time,
wherein the target time offset is determined based on a transmission delay of the SR on the uplink carrier and a signal transmission delay on at least one downlink carrier, the at least one downlink carrier being a downlink carrier activated between a terminal device and a base station.

2. The method according to claim 1, wherein the method is applied in an application scenario comprising any one of:
Carrier Aggregation, CA, between a Terrestrial Network, TN and a Non-Terrestrial Network, NTN;
NTN CA with transparent forwarding by different satellites;
a combination of Dual-Connectivity, DC, and CA between a TN and an NTN; or
a combination of DC and CA between different NTNs.

3. The method according to claim 1, wherein
when one DRX packet is configured for a Media Access Control, MAC, entity, and DRX active times are maintained by the terminal device uniformly for the MAC entity, the target time offset is determined based on the transmission delay of the SR on the uplink carrier and a first signal transmission delay, wherein
the first signal transmission delay is a minimum one of signal transmission delays on all activated downlink carriers in a cell group where the uplink carrier is located, said all activated downlink carriers being downlink carriers between the terminal device and the base station.

4. The method according to claim 3, wherein the target time offset is a sum of the transmission delay of the SR on the uplink carrier and the first signal transmission delay, or the target time offset is greater than a sum of the transmission delay of the SR on the uplink carrier and the first signal transmission delay.

5. The method according to claim 1, wherein
when one DRX packet is configured for a Media Access Control, MAC, entity, and DRX active times are maintained by the terminal device separately for individual serving cells corresponding to the MAC entity, the target time offset is determined, for any one of the individual serving cells, based on the transmission delay of the SR on the uplink carrier and a signal transmission delay on a downlink carrier corresponding to the serving cell, wherein
the downlink carrier corresponding to the serving cell is a downlink carrier between the terminal device and the base station.

6. The method according to claim 5, wherein the target time offset is a sum of the transmission delay of the SR on the uplink carrier and the signal transmission delay on the downlink carrier corresponding to the serving cell, or the target time offset is greater than a sum of the transmission delay of the SR on the uplink carrier and the signal transmission delay on the downlink carrier corresponding to the serving cell.

7. The method according to claim 1, wherein
when a plurality of DRX packets is configured for a Media Access Control, MAC, entity and DRX active times are maintained by the terminal device separately for the plurality of DRX packets, the target time offset is determined, for any one of the plurality of DRX packets, based on the transmission delay of the SR on the uplink carrier and a second signal transmission delay, wherein
the second signal transmission delay is a minimum one of signal transmission delays on all activated downlink carriers corresponding to the DRX packet, said all activated downlink carriers being downlink carriers between the terminal device and the base station.

8. The method according to claim 7, wherein the target time offset is a sum of the transmission delay of the SR on the uplink carrier and the second signal transmission delay, or the target time offset is greater than a sum of the transmission delay of the SR on the uplink carrier and the second signal transmission delay.

9. The method according to claim 1, wherein
when a plurality of DRX packets is configured for a Media Access Control, MAC, entity, DRX active times are maintained by the terminal device separately for the plurality of DRX packets, and cross-carrier scheduling on carriers corresponding to different DRX packets is not supported by the terminal device, the target time offset is determined, for a first DRX packet in the plurality of DRX packets, based on the transmission delay of the SR on the uplink carrier and a third signal transmission delay, wherein
the first DRX packet is a DRX packet meeting a predetermined condition among the plurality of DRX packets, and the third signal transmission delay is a minimum one of signal transmission delays on all activated downlink carriers corresponding to the first DRX packet, said all activated downlink carriers being downlink carriers between the terminal device and the base station.

10. The method according to claim 9, wherein the target time offset is a sum of the transmission delay of the SR on the uplink carrier and the third signal transmission delay, or the target time offset is greater than a sum of the transmission delay of the SR on the uplink carrier and the third signal transmission delay.

11. The method according to claim 9, wherein
the predetermined condition comprises that the SR is triggered by a regular Buffer Status Report, BSR, triggered for an uplink logical channel, and
the uplink logical channel is determined, based on a Link Control Protocol, LCP, restriction of the uplink logical channel, to be allowed to be transmitted on at least one serving cell corresponding to the first DRX packet.

12. The method according to claim 9, wherein the predetermined condition comprises that the SR is triggered by an event other than a regular BSR triggered for an uplink logical channel.

13. A terminal device, comprising a processor and a memory, wherein the memory is configured to store a computer program, and the processor is configured to invoke and execute the computer program stored in the memory to perform operations comprising:
transmitting a Scheduling Request, SR, on an uplink carrier; and
entering, when the SR is in a pending state after a target time offset following transmission of the SR, a Discontinuous Reception, DRX, active time,
wherein the target time offset is determined based on a transmission delay of the SR on the uplink carrier and a signal transmission delay on at least one downlink carrier, the at least one downlink carrier being a downlink carrier activated between the terminal device and a base station.

14. The terminal device according to claim 13, wherein the terminal device is applied in an application scenario comprising any one of:
Carrier Aggregation, CA, between a Terrestrial Network, TN and a Non-Terrestrial Network, NTN;
NTN CA with transparent forwarding by different satellites;
a combination of Dual-Connectivity, DC, and CA between a TN and an NTN; or
a combination of DC and CA between different NTNs.

15. The terminal device according to claim 13, wherein
when one DRX packet is configured for a Media Access Control, MAC, entity, and DRX active times are maintained by the terminal device uniformly for the MAC entity, the target time offset is determined based on the transmission delay of the SR on the uplink carrier and a first signal transmission delay, wherein
the first signal transmission delay is a minimum one of signal transmission delays on all activated downlink carriers in a cell group where the uplink carrier is located, said all activated downlink carriers being downlink carriers between the terminal device and the base station.

16. The terminal device according to claim 15, wherein the target time offset is a sum of the transmission delay of the SR on the uplink carrier and the first signal transmission delay, or the target time offset is greater than a sum of the transmission delay of the SR on the uplink carrier and the first signal transmission delay.

17. The terminal device according to claim 13, wherein
when one DRX packet is configured for a Media Access Control, MAC, entity, and DRX active times are maintained by the terminal device separately for individual serving cells corresponding to the MAC entity, the target time offset is determined, for any one of the individual serving cells, based on the transmission delay of the SR on the uplink carrier and a signal transmission delay on a downlink carrier corresponding to the serving cell, wherein
the downlink carrier corresponding to the serving cell is a downlink carrier between the terminal device and the base station.

18. The terminal device according to claim 17, wherein the target time offset is a sum of the transmission delay of the SR on the uplink carrier and the signal transmission delay on the downlink carrier corresponding to the serving cell, or the target time offset is greater than a sum of the transmission delay of the SR on the uplink carrier and the signal transmission delay on the downlink carrier corresponding to the serving cell.

19. The terminal device according to claim 13, wherein
when a plurality of DRX packets is configured for a Media Access Control, MAC, entity and DRX active times are maintained by the terminal device separately for the plurality of DRX packets, the target time offset is determined, for any one of the plurality of DRX packets, based on the transmission delay of the SR on the uplink carrier and a second signal transmission delay, wherein
the second signal transmission delay is a minimum one of signal transmission delays on all activated downlink carriers corresponding to the DRX packet, said all activated downlink carriers being downlink carriers between the terminal device and the base station.

20. The terminal device according to claim 19, wherein the target time offset is a sum of the transmission delay of the SR on the uplink carrier and the second signal transmission delay, or the target time offset is greater than a sum of the transmission delay of the SR on the uplink carrier and the second signal transmission delay.
